(19) United States
(12) Patent Application Publication
(10) Pub. No.: US 2007/0173244 A1
(43) Pub. Date: Jul. 26, 2007

(54) A Method For Establishing A Service Connection

(75) Inventors: Bing Xu, Shenzhen (CN); Jinhui Shi, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 11/164,348

(22) Filed: Nov. 18, 2005

Related U.S. Application Data
(63) Continuation of application No. PCT/CN04/00510, filed on May 19, 2004.

(30) Foreign Application Priority Data
May 19, 2003 (CN) 03136083.1

(51) Int. Cl. H04Q 7/20

(52) U.S. Cl. 455/422.1; 455/525

(57) ABSTRACT

The present invention provides a method for establishing a service connection, comprising: before initiating a service request, UE will select a cell that can provide the said service; if a cell that can provide the said service is selected, UE will send a service request to the network in the cell that can provide the said service, and establish the service connection with the network; if no cell that can provide the said service is selected, UE will notify the subscriber that service connection is unsuccessful. UE performs cell selection/reselection according to the requested service and will not send a service request to the network until selecting a proper cell to reside, the process thereof can greatly increase service access probability and improve service quality, thus increasing subscribers' satisfaction toward services and promoting service expansion and application.

### CROSS REFERENCE TO RELATED APPLICATIONS

This application is a continuation of International Application No. PCT/CN2004/000510 filed May 19, 2004 which claims priority to Application 03136083.1 filed on May 19, 2003 in China. The disclosures of the above-referenced are incorporated by reference herein.

### FIELD OF THE INVENTION

The present invention relates generally to mobile communication technique field, more particularly to a method for establishing a service connection between user equipments and networks.

### BACKGROUND OF THE INVENTION

With the development of wireless technique, various wireless access techniques have emerged, accordingly there are wireless networks adopting different techniques, like Global System for Mobile Communication (GSM) network and Code Division Multiple Access (CDMA) network in the second generation mobile communication, Wide Code Division Multiple Access (WCDMA) network and CDMA2000 network in the third generation mobile communication. As a result, User Equipment (UE), including single mode user equipment and multi mode user equipment, will need to select a network to reside in a proper cell after powered on, and detect the system messages and paging messages of this cell when in the idle state so as to initiate certain service requests to the network or receive service requests of other UEs.

At present, after UE is power-on, it will select a proper PLMN (Public Land Mobile Network) according to a PLMN list which is self-maintained and available, reside accordingly in a proper cell of this PLMN and register location area information. After residing in a proper cell, when in the idle state, UE will periodically initiate cell reselection according to detected signals of other cells to reside in a more proper cell. Of course, it is possible that UE may reselect a more proper PLMN to reside. In the process of PLMN selection/reselection and cell selection/reselection, UE always selects a cell with the best signal to reside. The above-mentioned UE comprises single mode UE and multi mode UE.

In addition, a preferable network can be set in UE, for instance, if double-mode UE corresponding to GSM/WCDMA sets the WCDMA network as preferable, while there are both GSM network and WCDMA network, this UE will first select a cell in WCDMA network to reside.

FIG. 1 is a schematic diagram illustrating the service access procedure in the prior art, as shown in FIG. 1, the service access procedure when UE initiates a service request to the network comprises the following steps:

Step 101˜step 102: UE initiates a service request to the network, after receiving the service request, the network judges whether it is able to provide the service that UE requests, if yes, execute step 103; otherwise, execute step 104.

Step 103: the network establishes a service connection with UE and provides UE with the service that UE requests.

Step 104: the network returns a unsuccessful service request response to UE, and rejects to provide the service that UE requests. After receiving the unsuccessful service request response, UE can notify the subscriber through an interface that the service connection is unsuccessful.

It can be seen from the above process that, after UE selects a cell with the best signal to reside, UE will send a service request to the network in the cell where it has resided when desiring a service connection. If the network which this cell belongs to cannot provide the service that UE requests, the network will reject UE's request for the service, even if this UE has actually subscribed to this service. As a result, service access probability is reduced and subscribers are not satisfied. The said service access probability is a comprehensive parameter taking into account the access probabilities of all services available in the cell, namely comprehensive access probability of all services available in the cell. Therefore, the above-described service refers to all services that a cell can provide.

### BRIEF SUMMARY OF THE INVENTION

Therefore, object of the present invention is to provide a method for establishing a service connection so as to greatly increase service access probability and improve service quality.

To realize the above object, the present invention provides a method for establishing a service connection, comprising:

A. before initiating a service request, UE (User Equipment) selecting a cell that is able to provide the said service, if such a cell is found, executing step B; otherwise, executing step C;

B. UE initiating a service request to the network in the cell that is able to provide the said service and establishing a service connection with the network, and then ending the procedure of establishing the service connection;

C. UE notifying a subscriber that the service request is unsuccessful.

The step of selecting the cell that can provide the said service in step A comprises:

A1. UE first judging whether the current cell in which it resides is able to provide the said service, if yes, executing step B, otherwise, executing step A2;

A2. UE determining another cell that is able to cover the current area and provide the said service.

The said step A2 comprises:

A21. UE searching for other cells that cover the current area, if found, executing step A22, otherwise, executing step C;

A22. UE judging whether the found cells are able to provide the said service, if yes, executing step A23, otherwise, executing step C;

A23. UE residing in the found cell that is able to provide the said service with the signal of best quality.

The step of judging whether the cell is able to provide the said service comprises: judging whether the cell is able to provide the said service according to the cell capability information provided by the cell.

According to the method provided by the present invention, UE initiates a cell selection/reselection according to the requested service so as to select a proper cell to reside before sending a service request to the network. In this way, service connection—on probability and service quality are greatly improved, subscribers' demand for services is satisfied and service extension and application is promoted.

According to this invention, a mechanism of triggering cell selection/reselection by UE based on a requested service is provided. In practical applications, it is possible to combine this mechanism with the cell selection/reselection mechanism in the prior art to obtain an optimized mechanism for cell selection/reselection .

### BRIEF DESCRIPTION OF THE DRAWINGS

FIG. 1 is a schematic diagram illustrating the service access procedure in prior art;

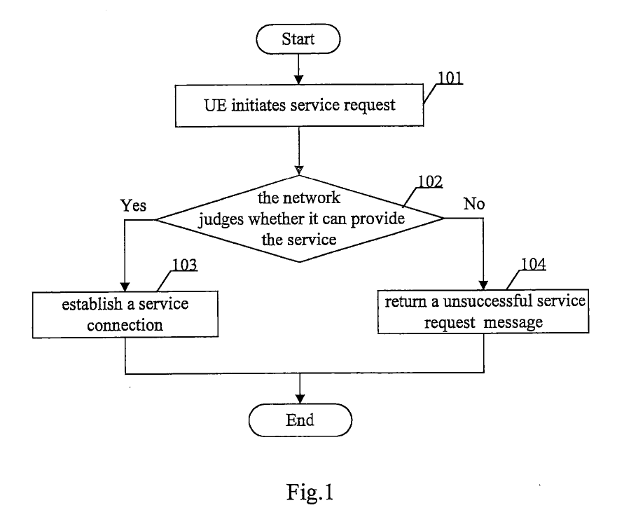

FIG. 2 is a schematic diagram illustrating the service access procedure in accordance with the present invention.

### DETAILED DESCRIPTION OF THE INVENTION

The present invention will be described in detail hereinafter with reference to the accompanying drawings.

In the present invention, the user equipment selects/reselects a cell according to the requested service, and sends a service request to the network after selecting a proper cell to reside. In this way, service access probability is greatly increased and service quality improved.

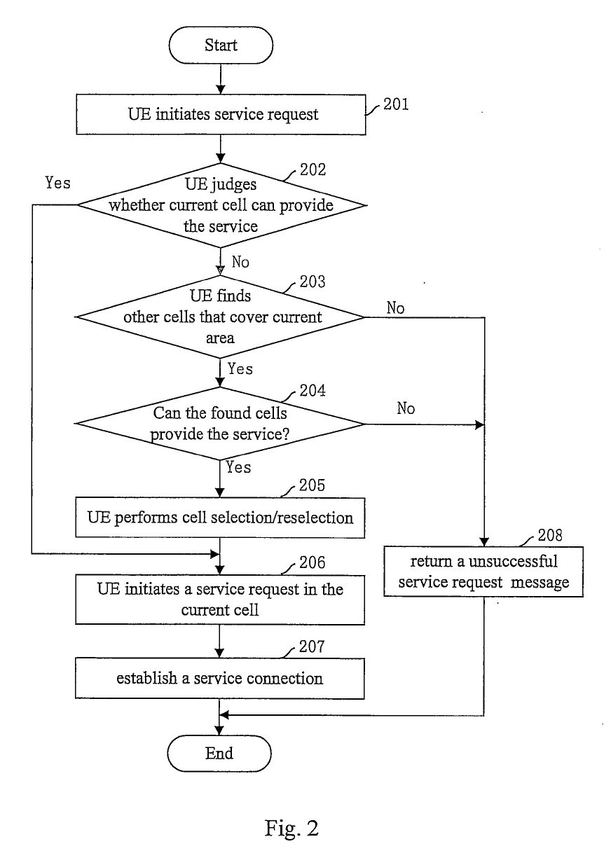

FIG. 2 is a schematic diagram illustrating the service access procedure in accordance with the present invention. As shown in FIG. 2, implementation of the service access procedure of the present invention comprises the following steps:

Step 201˜step 202: the subscriber notifies UE to send a service request to the network through a high-layer service interface, UE judges whether the current cell where it resides can provide the requested service, if yes, execute step 206; otherwise, execute step 203. The high-layer service interface can be the input interface. When selecting a cell, UE will interact with the cell, that is, UE provides its capability information to the cell where it resides and the cell where UE resides provides the cell capability information to UE. Therefore, UE can determine whether the current cell can provide the requested service. The said cell capability information refers to the information on what services the cell can provide.

Step 203: UE judges whether other cells that cover the current area are found, if yes, execute step 204; otherwise, execute step 208.

Step 204: UE judges whether the found cells can provide the requested service, if yes, execute step 205; otherwise, execute step 208.

Step 205: UE selects a cell, and it is still the cell with the signal of best quality that is selected. The selection this time, however, is from the cell list which comprises the cells that can provide the requested service.

Step 206˜step 207: UE sends a service request to the network in the current cell where it resides; after receiving the service request, the network establishes a service connection with UE and the procedure of establishing the service connection is over.

Step 208: after receiving unsuccessful service request response, UE notifies the subscriber through the high-layer service interface that the service connection is unsuccessful.

While in the idle state, UE will initiate a cell selection/reselection procedure selectively according to the service requested by the subscriber to reside in a proper cell before initiating the corresponding service request to the network.

In practical applications, it is possible to combine the mechanism provided by this invention, i.e. UE triggering cell selection/reselection according to the requested service, with the cell selection/reselection mechanism in the prior art so as to obtain an optimized cell selection/reselection mechanism. The said combination for optimized mechanism means using different cell selection method or combination of methods in accordance with different circumstances.

Before initiating a service request to the network, UE judges whether the current cell can provide the corresponding service, if the network cannot provide this service, UE will not send the service request to the current cell. As a result, the processing load of the cell where UE currently resides can be greatly reduced.

UE will not send a service request to the network before performing cell selection/reselection according to the triggering service and finding a cell that can provide the corresponding service, after that, UE will establish a service connection with the network. The above whole procedure is shielded from the subscriber, so the subscriber will feel no difference from initiating a service in the current cell. In this way, the subscriber does not have to be concerned with whether the current cell can provide the corresponding service while UE will search for a proper cell automatically, which brings great convenience to the subscriber.

To sum up, the above description is just a preferred embodiment of the present invention, not used to confine the protection scope of this invention.

What is claimed as new and desired to be protected by Letters Patent of the United States is:

1. A method for establishing a service connection, comprising:
A. before initiating a service request, UE (User Equipment) selecting a cell that is able to provide the said service to reside, if the cell is found, executing step B; otherwise, executing step C;
B. UE initiating a service request to the network in the cell that is able to provide the said service and establishing a service connection with the network, and then ending the procedure of establishing a service connection;
C. UE notifying a subscriber that the service request is unsuccessful.

2. A method according to claim 1, wherein the step A, selecting the cell that can provide the said service to reside comprises:
AUE first judging whether the current cell is able to provide the said service, if yes, executing step B, otherwise, executing step A2;
AUE determining another cell that covers the current area and is able to provide the said service.

3. A method according to claim 2, wherein the step A2 comprises:
AUE searching for other cells that cover the current area, if found, executing step A22, otherwise, executing step C;
AUE judging whether the found cells are able to provide the said service, if yes, executing step A23, otherwise, executing step C;
AUE residing in the found cell that is able to provide the said service with the signal of best quality.

4. A method according to claim 2, wherein the step of judging whether the cell is able to provide the said service comprises: judging whether the cell is able to provide the said service according to cell capability information provided by the cell.

5. A method according to claim 3, wherein the step of judging whether the cell is able to provide the said service comprises: judging whether the cell is able to provide the said service according to cell capability information provided by the cell.
